(19) United States
(12) Patent Application Publication
(10) Pub. No.: US 2026/0356744 A1
(43) Pub. Date: Nov. 12, 2026

(54) LOW-EMISSIVITY COATINGS WITH TRANSPARENT CONDUCTIVE POLYMERS AND METHODS

(71) Applicant: Purdue Research Foundation, West Lafayette, IN (US)

(72) Inventors: Xiulin Ruan, West Lafayette, IN (US); Wonjune Lee, West Lafayette, IN (US); Xiaojie Liu, West Lafayette, IN (US); Jianguo Mei, West Lafayette, IN (US)

(21) Appl. No.: 19/658,003

(22) Filed: Apr. 24, 2026

Related U.S. Application Data
(60) Provisional application No. 63/794,705, filed on Apr. 25, 2025.

(51) Int. Cl. C03C 17/42

(52) U.S. Cl. CPC C03C 17/42; C03C 2217/74

(57) ABSTRACT

Low-emissivity (low-e) coatings with transparent conductive polymers and methods relating thereto. The low-e coatings include a base layer of colored paint and a low-e layer formed of a transparent conductive polymer disposed on the base layer, wherein the low-e layer is infrared-reflective. Methods of fabricating the low-emissivity coating include applying the base layer onto the exterior surface of a substrate, and then applying the low-e layer onto the surface of the base layer after the base layer has been applied to the exterior surfaces. Methods of using low-e coatings include reducing heating and/or cooling energy consumption in a building by coating an exterior surface of the building with a low-e layer of alcohol-based n-PBDF ink solution.

### CROSS-REFERENCE TO RELATED APPLICATIONS

This application claims priority to provisional U.S. Patent Application No. 63/794,705 filed Apr. 25, 2025, the contents of which are incorporated herein by reference.

### BACKGROUND OF THE INVENTION

The invention generally relates to low-emissivity coatings and methods related thereto.

It is desirable to regulate the thermal losses and/or changes between the interior environment and the exterior environment of buildings for both comfort and environmental reasons. There are two primary strategies for thermal regulation in buildings: active methods, which rely on energy-intensive air conditioning, and passive methods, which use advanced materials to naturally modulate heat transfer. Active methods include standard heating and/or air conditioning equipment, which uses some form of energy source to actively heat and/or cool the interior of the building. The passive methods include thermochromic windows, thermal insulation materials, and daytime radiative cooling materials.

In typical architecture, walls typically account for approximately 25% of heat exchange between interior and exterior environments, with exterior surfaces exchanging heat through convection and infrared radiation. Traditional materials like brick, stone, glass, and concrete have high thermal emissivity, causing temperature swings and discomfort. High-emissivity materials can lead to overheating in hot climates and excessive heat loss in cold climates. To address these challenges, radiative cooling materials can be developed to have high emissivity only in the sky window band (8-13 μm wavelength energy), allowing for heat exchange in this band while rejecting heat out of this band from hot surroundings. However, this does not solve cold climate issues, where heat loss remains a concern.

Another type of coating materials, conventional low-emissivity (low-e) paints are characterized by their low thermal emissivity across the entire mid-infrared (MIR) band (2.5-20 um wavelength) and often in the near-infrared (NIR) band (0.8-2.5 μm wavelength). This property enables these low-e paints to minimize heat exchange with the surrounding environment, creating a more stable indoor climate in both hot and cold climates. Most commercial low-e paints use metallic materials like silver particles or aluminum flakes to achieve low emissivity. However, these low-e paints have a metallic appearance that may not meet certain aesthetic requirements and/or can lose their low emissivity over time due to the oxidation of metal particles.

In contrast, another known low-e coating has a bilayer paint with an IR-transparent colored top layer containing inorganic nanoparticles (e.g., Prussian blue, iron oxide, goethite, zinc oxide) and a low-e bottom layer of aluminum flakes in an IR-transparent organic binder. However, the high cost of the IR-transparent binders limits scalability for commercial use.

To address this, conductive polymers, such as PEDOT: PSS (Poly (3,4-ethylenedioxythiophene): polystyrene sulfonate) may offer an alternative to metals for low-e paints. However, these conductive polymers face challenges, including the need for external dopants, additional post-treatment and thermal drying process, a lack of color, stability issues under environmental stress (e.g., moisture, UV exposure), lower conductivity, and thicker films with reduced light transmittance. However, no studies have yet demonstrated scalable, colored, and durable low-e paints.

Therefore, it would be desirable to have low-e paints that can have a broader range of colors, improved durability, and/or improved scalability for commercial production.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, low-emissivity coatings, methods of reducing heating and/or cooling energy consumption in buildings, and methods of fabricating the low-emissivity coatings

According to a nonlimiting aspect of the invention, a low-emissivity coating includes a base layer of colored paint and a low-e layer formed of a transparent conductive polymer disposed on the base layer. The low-e layer is infrared-reflective.

According to another nonlimiting aspect of the invention, a method of reducing heating and/or cooling energy consumption in a building includes coating an exterior surface of the building with a low-e layer of ethanol-based n-PBDF ink solution.

According to yet another nonlimiting aspect of the invention, a method of fabricating a low-emissivity as described above includes applying the base layer onto the exterior surface of a substrate, and applying the low-e layer onto the surface of the base layer after the base layer has been applied to the exterior surfaces.

Technical aspects of low-e coatings as described above preferably include the ability to provide low-e paints that have a broad range of colors, improved durability, and/or improved scalability for commercial production.

These and other aspects, arrangements, features, and/or technical effects will become apparent upon detailed inspection of the figures and the following description.

### BRIEF DESCRIPTION OF THE DRAWINGS

FIG. 1 is a schematic illustrating of a low-e coating (“low-e paint”) according to certain aspects of the present invention.

FIG. 2 is a schematic representation of a process for applying the low-e coating according to certain aspects of the invention.

FIG. 3 represents a photograph (left side) and a corresponding IR image (right side) of a letter “P” formed by a low-e coating of the present invention and showing temperature contrast with the surrounding commercial black paint substrate having high thermal emittance.

FIG. 4 shows graphs representing the distribution of the diameters of nano-scale aggregate particles formed on an n-PBDF film surface, with data for the upper graph obtained from SEM and data for the lower graph obtained from AFM phase image.

FIG. 5 is a graph representing ATR FT-IR spectra for four different thickness n-PBDF films with glass/black-painted substrates.

FIG. 6 is a graph representing UV-Vis-NIR absorption spectrum of n-PBDF inks of the present invention diluted over 20-fold (inset: serial-diluted n-PBDF ink solutions).

FIG. 7 is a graph representing reflectance spectra of low-e black paint, n-PBDF particles, and commercial black paint. The inset shows their photographs. All the samples were coated onto glass.

FIG. 8 is a graph representing the reflectance spectra of several commercial paints (solid curves) and the corresponding low-e versions (dashed curves) in the MIR region.

FIG. 9 is a graph representing temperature differences between commercial black paint and low-e black paint with the coating thickness of n-PBDF layer of 231 nm at various heating temperatures. The temperature values in the figure display the set temperature for the hot plates at each step with a time interval of 1 h.

FIG. 10 is a graph representing temperature differences between commercial black paint and low-e black paint with the coating thickness of n-PBDF layer of 231 nm at various cooling temperatures. The temperature values in each figure display the set temperature for the cooling plates at each step with a time interval of 1 h.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings and identifies certain but not all alternatives of the embodiment(s). As nonlimiting examples, the invention encompasses additional or alternative embodiments in which one or more features or aspects shown and/or described as part of a particular embodiment could be eliminated and encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The following disclosure describes low-emissivity (“low-e”) coatings (also referred to herein as “low-e paints”) that can have many various different colors. The low-e coatings have separate first and second layers, including a base layer and a low-e layer, that are disposed successively onto a substrate preferably so that the base layer and low-e layer contact each other.

The base layer forms a color-imparting coating. Typically, the base layer is a coating of colored (light-reflective) paint disposed on the substrate. The paint may have any color, such as white, black, gray, and/or any color in the visible light spectrum. For example, the base layer may be a typical commercially available architectural paint disposed on an architectural feature, such as a building wall, floor, ceiling, or roof. Typically, any suitable commercial paint can be used, such as paints that include at least one of BaSO₄, CaCO₃, TiO₂, and hexagonal boron nitride (BN).

The low-e layer is coated onto the surface of the base layer and allows the color of the base layer to be seen therethrough. The low-e layer is made of a transparent conductive polymer that is infrared-reflective, thereby allowing the commercial paint's color to be seen while also realizing high infrared (IR) thermal reflectance (i.e., low IR emissivity). Preferably, the low-e layer is the top (i.e., most exterior facing the outside environment) layer of the low-e coating facing any sunlight or other radiation source. In some embodiments, the low-e layer is made of n-doped poly (benzodifurandione) (n-PBDF) polymer, as a nonlimiting example, in the form of nanoparticles that can be mixed with ethanol to form a polymer ink solution (also called an “n-PBDF ink”) for easy application. After application, evaporation of the ethanol leaves predominantly or entirely a layer of the n-PBDF nanoparticles forming the low-e layer over the base layer. The low-e layer may have be formed to have various thicknesses, as a nonlimiting example, about 10 to about 400 nm, although other thicknesses are also possible. The low-emissivity coating preferably has an emissivity of about 0.02 to 0.9 in the mid-infrared spectrum. Advantageously, given the ultrathin coating thickness of the top low-e layer, light within the visible wavelength can pass this layer without undergoing significant absorption, hence revealing the color of the underlying colored paint layer.

The n-PBDF polymer is an n-type conducting polymer with high electrical conductivity, good solution processability, and good weathering stability having the chemical structure shown below.

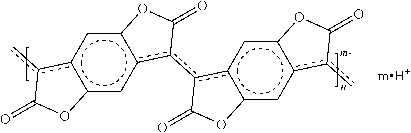

The n-PBDF polymer may be made, for example, using selenium dioxide (SeO2) catalyzed polymerization, molybdenum trioxide (MoO3) catalyzed polymerization, and/or other non-metal oxide and metal oxide catalyzed polymerization processes, for example as described in International Patent Application No. PCT/US2025/033046 and/or as described in Ke et al., “Highly Conductive and Solution-Processable n-Doped Transparent Organic Conductor,” J. Am. Chem. Soc. 2023, 145, 6, 3706-3715, available at https://doi.org/10.1021/jacs.2c13051, the contents of which are incorporated herein by reference. In one nonlimiting example, the n-PBDF polymer ink may be made using a selenium dioxide (SeO₂) catalyzed polymerization process. In this process, benzodifurandione (BDF) monomer is mixed with a selenium catalyst to form a BDF-selenium mixture. The BDF-selenium mixture is then dissolved in a dimethylsulfoxide (DMSO) solvent to form a pre-polymer solution of the BDF monomer, the selenium catalyst, and the solvent. The pre-polymer solution is then polymerized to form the n-PBDF polymer. Optionally, the polymerized n-PBDF may be purified to remove amu excess selenium and/or other unwanted final materials. Other methods of making the n-PBDF polymer may be used. As previously noted, the n-PBDF may be in the form of nanoparticles.

The substrate can be any material suitable for receiving a paint thereon. For example, the substrate may be made of wood, metal, ceramic, concrete, brick, glass, adobe, plastics, cloth, and/or any other paintable material. In some embodiments, the substrate may be typical architectural materials for building walls, floors, ceilings, roofs, and/or other architectural structures. In some embodiments, the substrate may be a vehicular structure, such as a metal or plastic automobile body part. However, the substrate may include other types of materials and/or structures and is not limited to architectural structures.

In contrast to previously known low-e coatings, the low-e coating is preferably capable of being made without using an infrared-transparent binder, low-emissivity metallic nanoparticles, and/or other low-emissivity inorganic nanoparticles.

The low-e coating can be applied in a multi-coat process. For example, the base layer may be applied onto the exterior surface of the substrate (including any other layers, such as old paint layers), such as a wall or roof. Thereafter, the low-e layer is applied onto the exterior (exposed) surface of the base layer. The low-e layer may be applied either before or after the base layer has dried. The layers may be applied by any suitable application method, such as by spraying, brushing, rolling, etc. In this way, the low-e coating can be easily coated onto surfaces of almost any shape and conform to the basic shape thereof without requiring additional shaping or formation. In other embodiments, the low-e coating may be formed by simply applying a coating of the low-e layer onto a previously painted surface, thereby adding the IR-reflective properties of the low-e layer to existing painted surfaces.

In some embodiments, low-e paints/coatings using an ultrathin layer of n-doped poly (benzodifurandione) (n-PBDF) sprayed on top of commercial paints in a scalable and energy-efficient manner are provided. Unlike metals in conventional low-e paints, in the present embodiment the n-PBDF provides intrinsic low-e functionality from its self-doping state across the entire IR range, offering substantial cost-saving potential in both process and material costs. The low-e layer is disposed on top of the colored commercial paint layer, eliminating the demand for costly IR-transparent binders and low-e metallic/inorganic nanoparticles. The n-PBDF coating reveals the colors of the underlying paint layer, maintaining the aesthetic appeal of the commercial paints. The n-PBDF nanoparticles show strong stability in accelerated indoor weathering tests, ensuring long-term performance. This solution-processed n-PBDF coating can be easily applied and helps reject MIR thermal radiation in hot summers while minimizing heat loss in winter. Theoretical modeling demonstrated that low-e walls maintain temperatures with smaller fluctuations compared to walls with commercial paint, which highlights the potential of the colored low-e paints of the present disclosure as an effective energy-saving strategy, reducing HVAC energy consumption by minimizing radiative heat exchange.

The low-e coatings are preferably capable of being used to reduce the heating and/or cooling energy used in maintaining the interior of a building at a desired temperature, for example, by coating exterior surfaces of the building with the low-emissivity coating. Advantageously, applying the low-e coating in some embodiments can act both to reduce inflow of environmental heat into a building when the outside environment is warmer than the interior of the building (e.g., in summer) and to reduce the outflow of interior heat to the outside environment when the outside environment is cooler than the interior of the building (e.g., in winter). Although the low-e layer is very thin, starting from a wavelength of 0.8 μm, the low-e layer can still reflect the near-infrared (NIR) band of sunlight as well as mid-infrared (MIR) radiation from heat energy in the surrounding environment, exhibiting low emissivity in these bands and reducing radiative heating and cooling loads on buildings.

In contrast to previously known low-e technology mainly based on the metal materials as the functional material with oxidation concerns, the low-e paints disclosed herein use a conductive organic polymer, such as n-PBDF nanoparticles, with very good stability and durability when exposed to the solar radiation and high humidity environment. The fabrication of n-PBDF nanoparticles is solution-processable, which is suitable for mass production in the production application. In addition, unlike conventional low-e paints that mix or base the low-e ingredients, the low-e paints disclosed herein use the n-PBDF functional material with coating thickness of 150-250 nm as the upper layer. Because this upper layer is highly transparent in the visible wavelength range, it does not block the display of the underlying colorful appearances. Moreover, the low-e-function material can be sprayed or brushed on the base layer at an ultrathin thickness instead of being mixed with other materials, which can minimize the consumption of raw materials without affecting the optical properties. Because commercial paints with previously confirmed aesthetic properties may be used as the base layer, and their high emissivity in the MIR wavelength range is suppressed by the low emissivity of the overlying low-e layer, but in the visible range, their colorful appearance is exploited and reflected, providing a near infinite range of color choices. Furthermore, the emissivity for the low-e paints disclosed herein in the MIR wavelength range can be adjusted by controlling the coating thickness of the top low-e layer. For example, in some investigations, as the thickness of the n-PBDF coating on the top layer increases, measured at 121, 143, 168, and 194 nm, respectively, the corresponding emittances for these low-e paints in the MIR wavelength ranges was measured at 0.4, 0.35, 0.32, and 0.28.

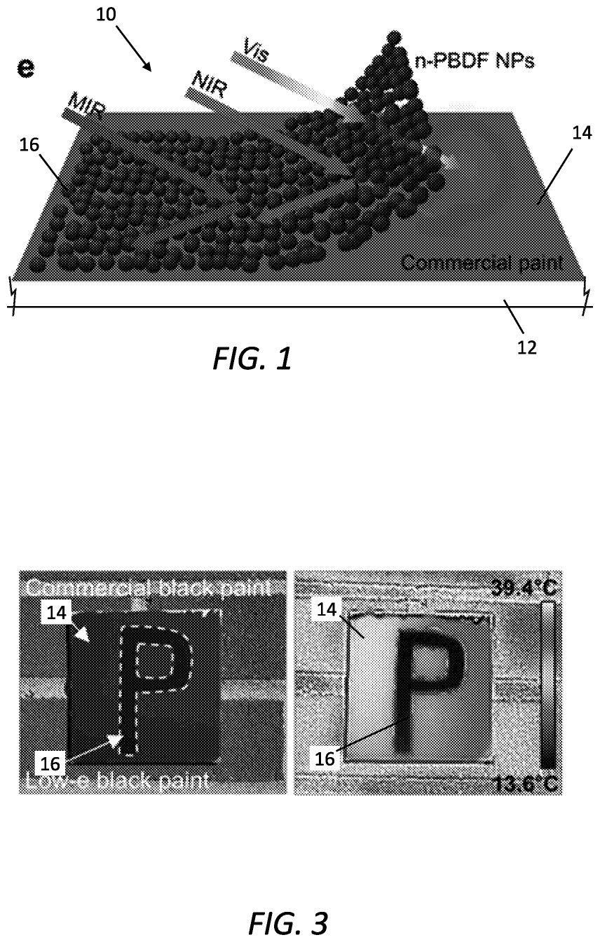

Turning now to the drawings, FIG. 1 illustrates a low-e coating (low-e paint) 10 coated onto a substrate 12. The low-e paint includes a bottom layer 14 that forms the base layer. The bottom layer 14 is a colored commercial paint that provides the desired appearance to satisfy aesthetic demands. The top layer 16 is the low-e layer. The top layer 16 is made of a visible-transparent n-PBDF nanoparticle-based coating layer with high thermal reflectance in the infrared region.

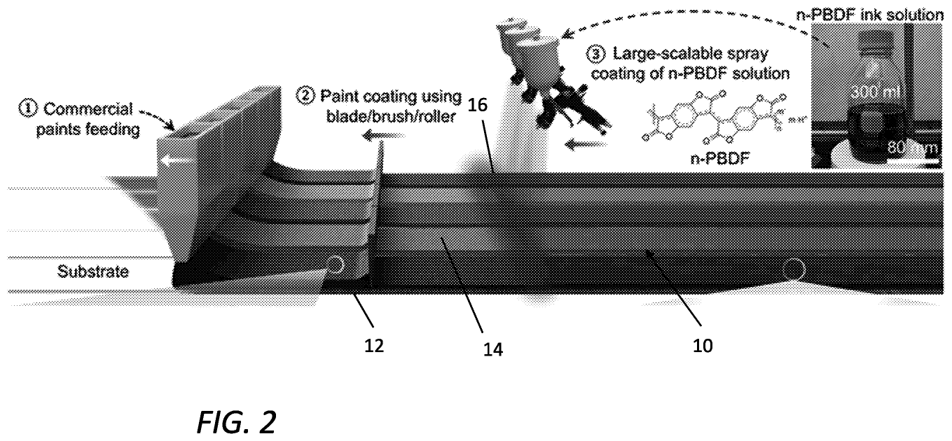

FIG. 2 illustrates one possible embodiment of a process of large-scale spray coating of the low-e paint 10 involving the coating of commercial paints of various colors, followed by the top coating of the prepared n-PBDF ink solution through a large-scale spray coating process. In this example, in a first step, the substrate 12 is pre-coated with one or more colored commercial paints using a brush, roller, blade, or sprayer to form the base layer 14. Thereafter in a second step, the n-PBDF ink solution is spray coated onto the base layer of colored paint to form the low-e layer 16. The low-e layer may be applied either before or after the base layer 14 has fully dried. The inset shows an ethanol-based n-PBDF ink solution, suitable for spray coating and easy scale-up for commercial usage. An advantage is that the ethanol-based n-PBDF ink solution is an environmentally friendly alcohol-based solvent. The ethanol-based n-PBDF ink solution also facilitates the preservation of the rigid backbone structure of n-PBDF during its formulation into a scalable sprayable ink. The inset shows a container of ethanol-based n-PBDF ink solution containing more than 300 ml of the n-PBDF ink solution, highlighting the solution properties, excellent dispersity, good stability, and homogenous ink. This also indicates the potential of n-PBDF ink to retrofit previously painted/colored surfaces to preserve the paint color while adding the desired low-e properties regardless of scale, including large building walls or vehicle exteriors.

Next, certain investigations leading to the present invention(s) are described, including nonlimiting examples of methods of fabricating the low-e coatings and different low-e coatings used for subsequent analyses and a summary of results of the subsequent analyses.

In the following examples, the following materials were used in the fabrication of the coatings: Dimethyl sulfoxide (DMSO, anhydrous), ethanol (anhydrous, 200 proof, 100% undenatured), onyx black paint, acrylic latex paints in green, blue, and yellow colors, Ford red paint, cellulose membrane dialysis bag tubing, and glass slides with thermal conductivity of 0.8 W/m K and specific heat capacity of 840-880 J/kg K.

N-type doped PBDF was synthesized in DMSO, as described in Ke et al., “Highly Conductive and Solution-Processable n-Doped Transparent Organic Conductor,” J. Am. Chem. Soc. 2023, 145, 6, 3706-3715, available at https://doi.org/10.1021/jacs.2c13051.

To fabricate the low-emissivity coatings, the commercial paints of various colors were applied to the glass substrates (glass slides) via custom home-built blade coating to form samples of various colors. The samples were then allowed to dry under ambient conditions for approximately four hours to form color-painted films.

To prepare the low-emissivity (low-e) n-PBDF ink solution, the synthesized n-PBDF solution was first dialyzed to 10 kDa. The dialyzed n-PBDF solution was then gradually added to stirred anhydrous ethanol at a 1:6 (v/v) ratio n-PBDF: ethanol, ensuring a highly homogenous dispersion. The mixture was stirred at room temperature and 500 rpm for at least 2 hours. This solution maintained its dispersion stability for more than two weeks.

For the fabrication of uniform and precise low-e n-PBDF films, an automated ultrasonic spray coating system was used. The system provided uniform coatings exceeding 100 nm in thickness, utilizing a 120 kHz ultrasonic spray nozzle with a liquid flow rate of 0.5 ml/min and nozzle-to-substrate distance of 50 mm, employing an arc-shaped pattern with repeated cycling.

To ensure reliability and reproducibility of the low-e n-PBDF films for subsequent analyses, film thickness precision (standard deviation+2%) was assessed using a surface profiler. The measurements were conducted at a minimum of five points across different batches of glass substrates under identical coating conditions.

Starting from colored commercial paint as the base layer 14, a visible-transparent and IR-reflective ultrathin layer 16 was applied at the top, allowing the paint color to be preserved while achieving high IR reflectance. The top layer 16 contained n-doped PBDF colloids (n-PBDF), an organic conjugated conductive polymer. Starting from a wavelength of 0.8 μm, the top coating showed an elevated reflectance and reduced the solar heating gain over the NIR region, facilitating energy saving during the summer. Meanwhile, the top layer showed high reflection over the MIR wavelengths, where the thermal radiation of room-temperature objects is concentrated. This appears to minimize the thermal radiation exchange between building envelopes and surroundings and to facilitate the thermal regulation of buildings across seasons.

With reference to FIG. 3, the low emissivity of n-PBDF can be visualized using a “P” pattern of n-PBDF sprayed on a printing paper surrounded by commercial black paint. The low-e layer 16 is coated in the shape of the letter “P” onto a background of commercial black paint 14. As can be seen on the right side of FIG. 3, despite the same temperature, the low-e “P” pattern in the IR image clearly demonstrates the low emissivity of the n-PBDF layer, because it emits less energy to the IR camera.

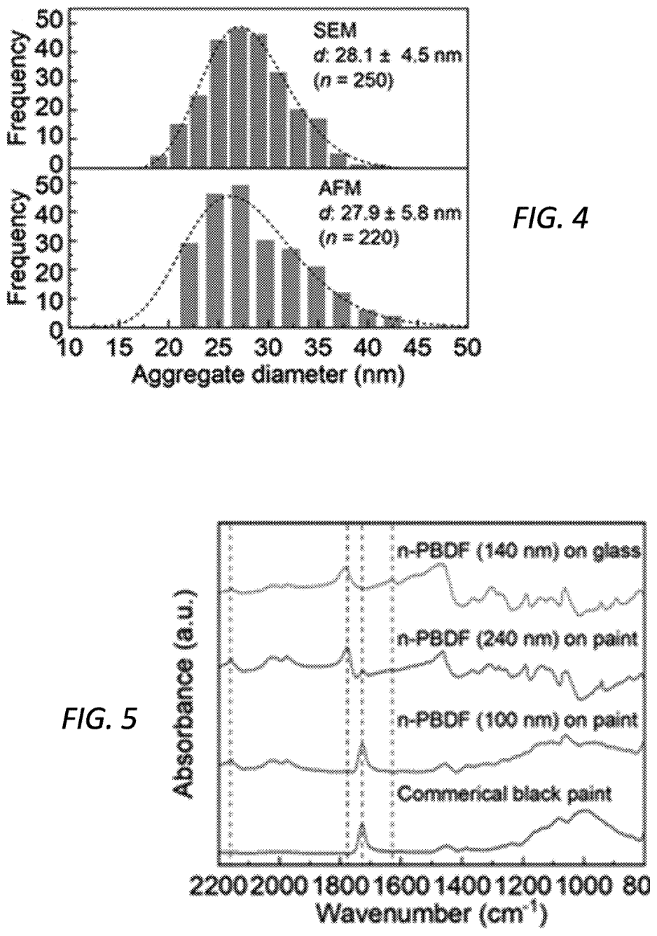

Scanning electron microscopy (SEM) images and atomic force microscopy (AFM) images corroborated the uniform nano-features of the n-PBDF particles ranging from 22 to 42 nm, with an average size of ~28 nm. FIG. 4 shows that the nano-particulate features of the n-PBDF film have an average diameter of about 28 nm. The nanoscale size of the particles significantly reduces visible light scattering, enabling high visible transmittance.

With reference to FIG. 5, attenuated total reflectance Fourier transform infrared spectroscopy was employed for qualitative analysis of the surface chemistry across four distinct samples. The commercial black paint layer 14 constitutes several fillers, adhesives, pigments, and other ingredients that result in the formation of strong peaks at 1,720 cm-1 (C—O stretching of ester/carboxyl groups), 1,165 and 1,074 cm-1 (Si—O stretching), and various symmetric and asymmetric absorption bands. The n-PBDF film 16 has shifted or new absorbance peaks at 1,790 cm-1 and 1,630 cm-1 and within 1,970-2,160 cm-1. The 1,790 cm-1 peak is ascribed to asymmetric C—O band stretching and is a spectral fingerprint for a 5-member lactone moiety. The clear spectral fingerprints of the two layers and the compatibility between the n-PBDF coating and paint layer, as well as the formation of the low-e paint, can be indirectly confirmed by the distinct stretching absorbance peaks observed when the n-PBDF film coexists with the low-e paint layer

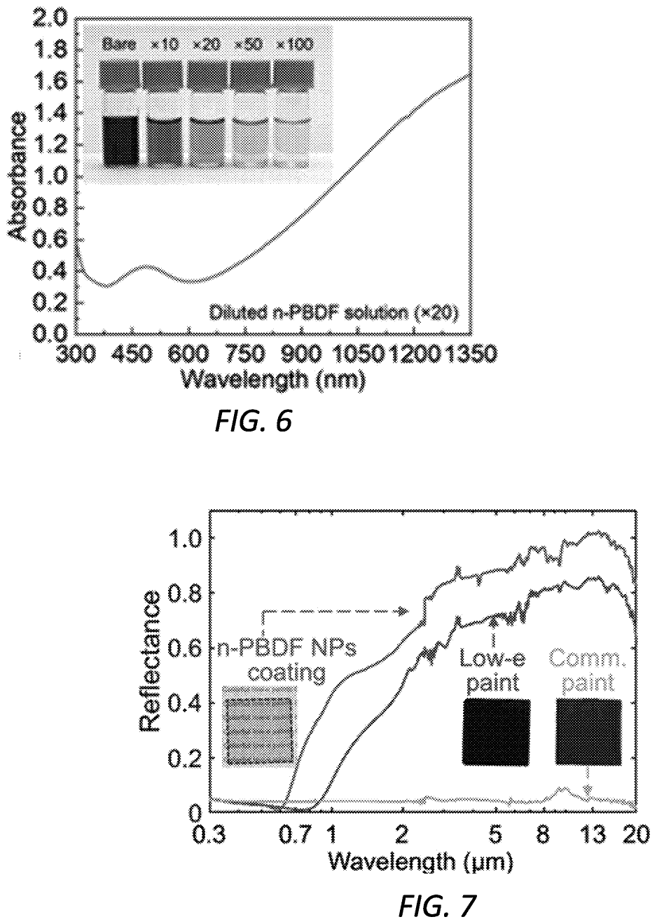

Testing of the samples showed that, as viewed with a thermal camera, the low-e paints of these samples had a very low surface temperature because their surface emissivity is very low, demonstrating restricted thermal radiation. In contrast, due to the high emissivity, the surface temperatures of the respective commercial paints counterparts were much higher. FIG. 6 shows a clear absorbance spectrum of the n-PBDF ink solution in the UV-Vis-NIR region. Despite being diluted more than 20-fold, the solution exhibited a distinct polaronic absorption that gradually increased in the NIR region. Both wavelength peaks, 487 and 1,350 nm, across varying dilution concentrations showed a linear fit of absorbance with concentration. This trend is in accordance with the Beer-Lamber law, confirming the presence of extinction coefficients that correlate with the concentration of the n-PBDF ink solution. Dynamic light scattering analysis was employed to determine the size distribution of the n-PBDF features within the ink solution, revealing an average hydrodynamic diameter of 76 nm. This result confirms the uniform and stable dispersion of n-PBDF features within the solvent, emphasizing the suitability of the n-PBDF ink solution for applications requiring uniform distribution and consistent performance across various substrates and paint layers.

The optical properties of the dual-layer low-e paint 10 with n-PBDF coatings 16 of different thicknesses on top of an opaque black paint layer 14 were investigated to reveal its functionality in reducing the thermal emittance of commercial paints. The reflectance spectra of the low-e black paint, commercial black paint, and pure n-PBDF nanoparticles coated on a glass slide were tested and shown in FIG. 7. The commercial paint showed a constant low reflectance throughout the solar and thermal wavelengths. Specifically, an average thermal reflectance of 0.05 indicates that, in a hot climate, it barely rejects heat gains from the surroundings; conversely, in a cold climate, it loses heat to its surroundings, hence increasing the heating demand. In striking contrast, the glass slide coated with the 194 nm-thick n-PBDF particles shows a sharp rise of reflectance from 0.6 μm and reaches around 0.95 over the MIR wavelengths. The reflectance of low-e black paint with the same 194 nm thick n-PBDF particle coating starts to rise from 0.8 μm and maintains a high reflectance of 0.81 in the MIR wavelength, equivalent to 0.19 emissivity. Therefore, it appears that adding the n-PBDF layer onto the commercial black paint simultaneously blocks NIR radiation from the sun and MIR radiation from the hot surroundings in hot summer, thereby reducing the cooling demand. Moreover, its radiation heat loss is suppressed in a cold climate due to its minimized emissivity. In addition, the thermal emissivity of the dual-layer low-e 10 paint was tunable by varying the thickness of the n-PBDF top layer 16. As the n-PBDF top layer 16 increased from 121 to 194 nm, the thermal reflectance elevated from 0.60 to 0.72, indicating a reduction in the thermal emissivity. To the naked eye, the visible colors of these low-e paints were very similar, but their corresponding IR thermal images showed a distinct reduction of “apparent temperature” due to reduced thermal emission as the n-PBDF layer thickness increased. The low-e paint with the thickest n-PBDF top coating showed the lowest surface temperature in the IR thermal images.

The dual-layered structure of the low-e paints 10 allows the same n-PBDF-composed top layer 16 to be used with commercial paints of many various colors. Testing showed that base paint samples with a 143 nm-thick n-PBDF layer 16 coated thereon had a slightly darker color than the bare paints. Both the bare commercial-colored paints and the low-e versions 10 of the paints had similar chromaticity coordinates in the chromaticity diagram based on the CIE 1931 color space, suggesting that the addition of the n-PBDF layer does not significantly alter the perceived color of the base-layer paint. Moreover, commercial paints were closer to the edges of the chromaticity diagram, representing more saturated colors than low-e paints.

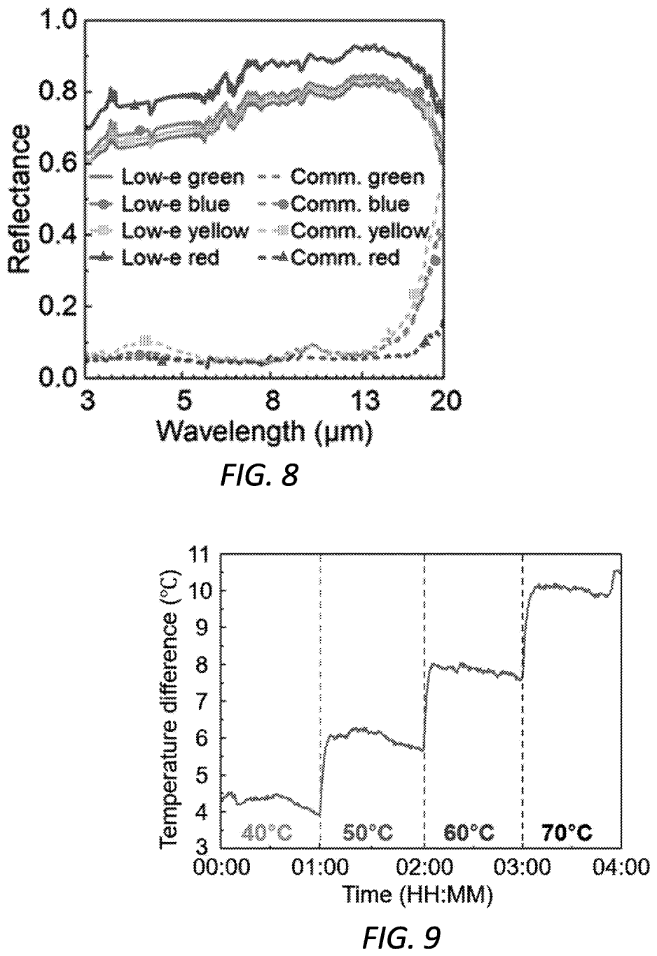

As seen in FIG. 8, over the MIR wavelengths, the reflectance spectra of the low-e paints showed trends similar to those of the n-PBDF layer alone. Taking blue as an example, the MIR reflectance of the commercial blue paint was only 0.10, whereas that of the low-e blue paint was as high as 0.80, which is an eight-fold enhancement.

Theoretical calculations show that a wall coated with low-e paint can stabilize its temperature in both hot and cold climates. Some models indicated that, in a hot climate with an ambient temperature of 30 °C and a road surface temperature of 60 °C, a wall painted with the low-e paint 10 (low-e wall) demonstrated a flat response to significant fluctuations in the neighboring object temperature compared with a wall coated with the corresponding commercial paint only (commercial wall). This characteristic may be used to prevent large temperature variations in building walls from regulating indoor temperatures and enhancing thermal comfort. Specifically, in some modeling, when the neighboring object's temperature exceeded 57 °C, the low-e wall showed a lower surface temperature, outperforming the commercial wall. Without wanting to be bound by theory, it is believed that this outcome arises because when the neighboring object has a relatively lower surface temperature (below 57 °C), the wall's absorption of radiation from the surroundings is limited compared to the thermal emission from the wall to the outer space; therefore, both the commercial wall and low-e wall exhibit a subambient surface temperature. Under such circumstances, owing to the high emissivity of the commercial wall in the MIR, it exhibits superior cooling performance by dissipating more thermal energy and providing a lower surface temperature than the low-e wall. However, when the surrounding objects exceed 57 °C, the commercial wall absorbs a significant amount of the incoming thermal irradiation, thereby offsetting and even surpassing the heat dissipated into outer space. In contrast, the low-e wall effectively rejected this incoming thermal energy and helped maintain a stable temperature (Figure S9, Supporting Information). In modeling of a cold climate, the ambient and road surface temperatures were both set to 5 °C. Regardless of the varying temperatures of the neighboring object ranging from −35 °C to 25 °C, the low-e wall consistently maintained a higher temperature than the commercial wall. Without wishing to be bound by theory, it is believed that this is because, even in cold climates, commercial walls with high surface emissivity dissipate thermal energy to outer space and cold surroundings, increasing the heating load on the building

The temperature response of low-e paint and commercial paint under controlled hot and cold conditions were investigated. Comparisons of samples of low-e black paints with n-PBDF coating thicknesses of 143, 194, and 231 nm on commercial black paint versus samples with pristine commercial black paint. All samples exhibited a temperature increase, with the commercial paint showing the highest temperature increase from ~32.5 °C to ~49.4 °C, while all samples with low-e paints exhibited a lower temperature increase. With reference to FIG. 9, the low-e paint with a 231 nm-thick n-PBDF coating layer (the sample with the highest thermal reflectance) exhibited the lowest temperature increase, further demonstrating the efficiency of the low-e paint in suppressing thermal energy uptake from the surroundings.

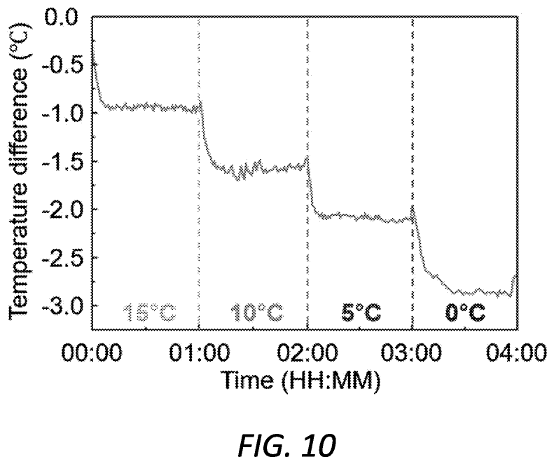

The temperature responses of the samples when the heating plate was fixed at 60 °C and the distance was varied from 20, 15, 10, to 5 cm was also investigated. The temperature profiles of all the samples exhibited an increase as the heating distance decreased. This indicates that the heat rejection effect of the low-e paints became more pronounced as they approached the heating source. As expected, the commercial paint consistently surpassed that of the low-e samples throughout the test. Temperature variations were recorded to study the paints' indoor thermal performance when facing a cooling source. These tests revealed that when the temperature of the cooling source decreased while the cooling distance between the samples and the cooling plate was fixed at 10 cm, the temperature of all samples progressively declined. Due to the high thermal emissivity of the commercial paint, it experienced the largest temperature reduction. With reference to FIG. 10, the low-e paints with increasing n-PBDF layer thickness exhibited smaller temperature drops, indicating that the low-e paint can effectively retain the temperature when faced with a cooler object. The temperature profiles of all the samples were recorded, beginning with a distance of 5 cm and a fixed cooling temperature of 0 °C. The surface temperatures of all samples increased as the cooling distance increased to 10 cm and subsequently to 15 cm. As more thermal energy loss occurs in commercial paints, they always display a much lower temperature than low-e paints at all cooling distances. Among the low-e paints, the one with the thickest coating layer with lower thermal emissivity showed the best temperature regulation effect, with a minimal temperature drop when facing a cooling source.

To study the transient thermal performance of the paints, an environmental box was established to simulate ambient temperatures of 65 °C and 5 °C, respectively. The temperature responses of commercial paint and the low-e paint with n-PBDF coating thicknesses of 143 and 213 nm, respectively, on glass slides were monitored. After these paints were exposed to hot or cold environmental boxes, the commercial paints showed a faster response of either increasing or decreasing temperature. In contrast, the low-e paints experienced slower temperature changes before eventually reaching thermal equilibrium with the environment due to their small thermal exchange with the surroundings.

Field tests were conducted outside during winter to investigate the thermal maintenance performance of the low-e paints disclosed herein in practical applications. Two structurally identical house models were built using the same wooden sheets painted with black walls and a white roof. The walls of one house were coated with commercial black paint, called a commercial house, and those of the other house were coated with low-e black paint, called a low-e house. The field tests showed that the thermal emissivity for the commercial house wall and low-e house wall are 0.95 and 0.31, respectively. Test results showed a difference in thermal performance that highlights the photothermal regulation advantages of the low-e paint 10. The thermal performance of the low-e paint was particularly evident in cold climates.

Computer simulation models were applied to evaluate the HVAC energy-saving performance by coating houses with the low-e paints 10. The simulations predicted that the low-e paint 10 can save heating and/or cooling energy in most climate zones. In the simulations, northern regions, characterized by extended periods of cold and dry climates, displayed the most substantial predicted energy savings. It is believed that this may be attributed to the heating demand dominating over cooling demand in these regions, and that the low-e paint 10 can reduce heat loss from the building walls. The simulations also showed that in mild and humid climates, the low-e paint still maintains significant energy savings.

From these investigations, it can be seen that the low-e paints 10 and methods disclosed herein can provide a scalable and durable colored low-e paint. The low-e paints 10 may have a dual-layer structure, including an ultrathin top n-PBDF coating layer and a colored commercial paint base layer. The low-e paints 10 can in some embodiments achieve significant thermal regulation while preserving the aesthetic appearance. In some embodiments, being a transparent organic conductor, a thin 200 nm top coating of n-PBDF on commercial paints was able to suppress the emissivity of a commercial paint from 0.95 to 0.19. Moreover, the coating thickness of the top n-PBDF layer can be adjusted to tune the thermal emissivity of the resulting paint, indicating significant flexibility in the thermal regulation and design of low-e paints. In some applications, the low-e paints 10 when coated on the exteriors of buildings can effectively reject thermal radiation from neighboring buildings and surroundings in hot climates while reducing thermal radiation loss in cold climates, enabling radiative thermal regulation of buildings, enhancing thermal comfort, and saving energy. Moreover, the low-e paints 10 are readily compatible with common application techniques, such as spraying and brushing, and can be easily adapted to diverse surface geometries, allowing for easy integration into existing building practices. It is believed that the low-e paints 10 can provide significant advantages in creating more energy-efficient building envelopes and/or can enhance thermal stabilization without sacrificing design aesthetics.

In some example embodiments, the present disclosure provides a new paint structure on a surface, the paint structure containing a paint base layer and a conductive polymer layer on top of and in contact with the paint base layer. In some embodiments, the conductive polymer layer contains n-PBDF. In some embodiments of this disclosure, the paint base layer contains colored paint, while in some other embodiments, commercial paint base layer contains white paint. In some embodiments of the paint structure of this disclosure, the n-PBDF layer is transparent and has thickness in the range of 10 nm-400 nm. In some embodiments of this disclosure, the paint structure has an emissivity in the range of 0.02-0.9 in the mid-infrared spectrum. In some embodiments of the paint structure of this disclosure, the thickness of the conductive polymer layer is about 200 nm, and the emissivity of the paint structure is 0.19 in the mid-infrared spectrum. In some embodiments of the paint structure of this disclosure, the paint base layer comprises one of BaSO₄, CaCO₃, TiO₂, and hexagonal BN. In some embodiments, the surface on which the paint structure is present is one of wood, a metal, an alloy, glass, plastic, and concrete.

As previously noted above, though the foregoing detailed description describes certain aspects of one or more particular embodiments of the invention, alternatives could be adopted by one skilled in the art. For example, the low-e coatings/paints and their components could differ in appearance and construction from the embodiments described herein and shown in the drawings, functions of certain components of the low-e coatings/paints could be performed by components of different construction but capable of a similar (though not necessarily equivalent) function, and various materials could be used in the fabrication of the low-e coatings/paints and/or their components. As such, and again as was previously noted, it should be understood that the invention is not necessarily limited to any particular embodiment described herein or illustrated in the drawings.

1. A low-emissivity coating comprising:
a base layer of colored paint; and
a low-e layer formed of a transparent conductive polymer disposed on the base layer, wherein the low-e layer is infrared-reflective.

2. The low-emissivity coating of claim 1, wherein the transparent conductive polymer comprises n-doped poly (benzodifurandione) (n-PBDF).

3. The low-emissivity coating of claim 2, wherein the n-PBDF is in the form of n-PBDF nanoparticles.

4. The low-emissivity coating of claim 1, wherein the colored paint has a color including at least one of white, black, and any color in the visible light spectrum.

5. The low-emissivity coating of claim 1, wherein the low-emissivity coating does not include an infrared-transparent binder.

6. The low-emissivity coating of claim 1, wherein the low-emissivity coating does not include low-emissivity metallic nanoparticles.

7. The low-emissivity coating of claim 6, wherein the low-emissivity coating does not include low-emissivity inorganic nanoparticles.

8. The low-emissivity coating of claim 1, wherein the low-e layer has a thickness of 10 nm to 400 nm.

9. The low-emissivity coating of claim 1, wherein the low-emissivity coating has an emissivity of 0.02 to 0.9 in the mid-infrared spectrum.

10. The low-emissivity coating of claim 1, wherein the colored paint of the first comprises at least one of BaSO₄, CaCO₃, TiO₂, and hexagonal BN.

11. A method of reducing heating and/or cooling energy consumption in a building, the method comprising coating an exterior surface of the building with a low-e layer of alcohol-based n-PBDF ink solution.

12. The method of claim 11, wherein the alcohol-based n-PBDF ink solution comprises a solution of n-PBDF nanoparticles in an ethanol solvent.

13. A method of fabricating the low-emissivity coating of claim 1, the method comprising:
applying the base layer onto the exterior surface of a substrate; and
applying the low-e layer onto the surface of the base layer after the base layer has been applied to the exterior surfaces.

14. The method of claim 13, wherein at least one of the base layer and the low-e layer is applied by at least one of spraying, rolling, blading, and brushing.

15. The method of claim 13, wherein applying the low-e layer comprises applying an ethanol-based n-PBDF ink solution and allowing the ethanol to evaporate to form a layer of n-PBDF nanoparticles.
